(19) United States
(12) Patent Application Publication
(10) Pub. No.: US 2025/0103227 A1
(43) Pub. Date: Mar. 27, 2025

(54) STORAGE DEVICE DYNAMIC STATE OPTIMIZATION VIA AN APPLICATION-AWARE HOST PROCESS

(71) Applicant: DELL PRODUCTS L.P., Round Rock, TX (US)

(72) Inventors: Farzad Khosrowpour, Pflugerville, TX (US); Nikhil Vichare, Austin, TX (US)

(21) Appl. No.: 18/472,988

(22) Filed: Sep. 22, 2023

(51) Int. Cl. G06F 3/06

(52) U.S. Cl. CPC G06F 3/0634; G06F 3/0625; G06F 3/0673

(57) ABSTRACT

An information handling system includes a storage device and a host operating system. The storage device operates in one of a plurality of operating modes. The host operating system determines an operating state of the information handling system, selects an operating mode based upon the operating state of the information handling system, and directs the storage device to operate in the selected operating state. The storage device implements the selected operating state in response to the direction.

### FIELD OF THE DISCLOSURE

This disclosure generally relates to information handling systems, and more particularly relates to storage device dynamic state optimization via an application aware host process in an information handling system.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

An information handling system may include a storage device and a host operating system. The storage device may operate in one of a plurality of operating modes. The host operating system may determine an operating state of the information handling system, select an operating mode based upon the operating state of the information handling system, and direct the storage device to operate in the selected operating state. The storage device may implement the selected operating state in response to the direction.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram of an information handling system according to an embodiment of the current disclosure;

FIG. 2 is a flowchart illustrating a method of storage device dynamic state optimization via an application aware host process in the information handling system of FIG. 1; and

FIG. 3 is a block diagram illustrating a generalized information handling system according to another embodiment of the present disclosure;

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

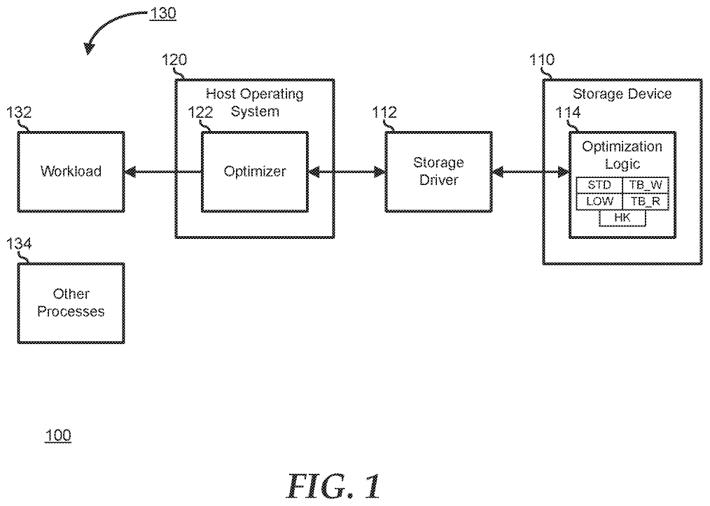

FIG. 1 illustrates an information handling system 100 similar to information handling system 300, described below. Information handling system 100 includes a storage device 110, and operates to instantiate a host operating system 120, various processes 130, and a storage device driver 112 that is provide in association with the storage device. Storage device 110 represents a solid state drive (SSD) device that stores data for information handling system 100, and may include a Serial ATA (SATA) device, a Non-Volatile Memory-Express (NVMe) device, an Enterprise and Data Center Standard Form Factor (EDSFF) device, an Intel Optane Persistent Memory device, or the like.

Storage device 110 includes optimization logic 114. Storage device 110 operates to provide internal housekeeping operations that ensure the reliability and longevity of the data stored thereon, such as wear leveling, redundancy operations, and the like. Typically, when storage device 110 is performing the housekeeping operations, other operations, such as data writes and data reads, as suspended for the duration of the housekeeping operations. Optimization logic 114 operates to manage the housekeeping operations, and to provide a housekeeping indication (HK) when the housekeeping operations are being performed. Further, storage device 110 can operate in one of several different optimized operating modes, including a standard (STD) operating mode, a low I/O (LOW) operating mode, a write-optimized, or TURBO-WRITE (TB_W) operating mode, and a read-optimized, or TURBO_READ, (TB_R) operating mode. The standard (STD) operating mode provides a baseline operational state with respect to data operations on storage device 110 and serves as a reference against the performance of the storage device, when operating in the other operating modes, is measured.

Storage device 110 may include a small memory region that is composed of volatile dynamic random access memory (DRAM) that operates as an on-device cache memory. In this regard, the low I/O (LOW) operating mode may represent an operating state where input and output operations (I/O) are minimized to, for example, reduce the power consumed by storage device 110. In the write-optimized (TB-W) operating mode, storage device 110 provides streamlined operation to improve the speed of data write transactions. Similarly, in the read-optimized (TB_R) operating mode storage device 110 provides streamlined operation to improve the speed of data read transactions.

Storage driver 112 represents firmware instantiated on information handling system 100 that provides an interface between host operating system 120 and storage device 110. In particular, data write and data read transactions from host operating system 120 are directed to storage driver 112 and the storage driver provides the data write and data read transactions to storage device 110. Storage driver 112 further operates to set up the operations of storage device 110 during a boot phase of operation of information handling system 100. Further, storage driver 112 operates to direct storage device 110 to operate in the various operating modes at the direction of host operating system 120, as described further below.

Host operating system 120 operates to instantiate processes 130, including a workload 132 and other processes 134. For the purposes of the current disclosure, workload 132 represents one or more application, utility, or process instantiated by host operating system 120, and that perform the functions and features as desired by a user of information handling system 100. An example of workload 132 may include audio or video content creation software, design software, database software, web server software, or other types of software represents a major usage to which information handling system 100 is put. In contrast, other processes 134 represent peripheral functions and features which may occur in a background mode of operation of information handling system 100. Stated another way, workload 132 may be understood to be one or more applications which a user desires to run with optimal performance, or which represents a major utilization of system resources, and which may be desired to be operated as efficiently as possible. In contrast other processes 134 may be understood to be of less importance to the user, or may represent a lower utilization of the system resources.

It has been understood by the inventors of the current disclosure that the steps taken to optimize the performance of an information handling system, either in terms of application performance, of resource utilization, of power consumption, or the like, do not typically include the optimization of the operation of storage devices. To this end, host operating system 120 includes an optimizer module 122 that operates to monitor and classify the activity of workload 132 in terms of the workload's utilization of storage device 110. Optimizer module 122 then operates to provide indications as to the classification of the activity of workload 132 to storage driver 112 to direct storage device 110 to change the storage driver's operating mode to match the classification and to optimize the storage device's operation for classification to improve the overall performance of the workload.

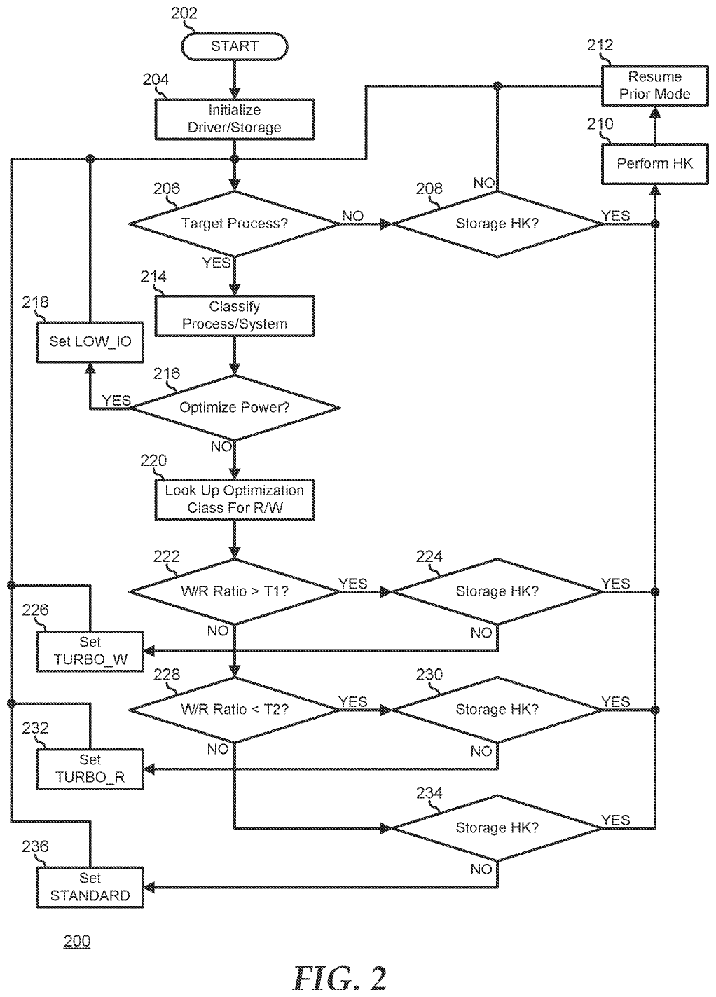

FIG. 2 illustrates a method 200 for storage device dynamic state optimization via an application aware host process in an information handling system similar to information handling system 100, starting at block 202. A storage device, such as storage device 110, is initialized in block 204. For example, a storage device driver, such as storage device driver 112, can be initialized during a power-on phase of operation of the information handling system, and the storage device can be identified and set up in, for example, a standard (STD) operating mode, as needed or desired. A decision is made as to whether or not a host operating system, such as host operating system 120, has identified a target process in decision block 206. If so, such as where host processing system 120 identifies workload 132, the “YES” branch of decision block 206 is taken and the method proceeds to block 214, as described below.

If the host operating system has not identified a target process, the “NO” branch of decision block 206 is taken and a decision is made as to whether or not the storage device is in need of housekeeping operations in decision block 208. If not, the “NO” branch of decision block 208 is taken and the method returns to decision block 206 until the host operating system identifies a target workload. If the storage device is in need of housekeeping operations, the “YES” branch of decision block 208 is taken and the storage device informs the storage device driver that the storage device has entered the housekeeping (HK) operating mode and performs the housekeeping operations in block 210. After the housekeeping operations are completed, the storage device resumes the prior operating mode, and informs the storage device driver of the operating state in block 212, and the method returns to decision block 206.

Returning to decision block 206, when the host operating system has identified the target process, and the “YES” branch of the decision block is taken, the host operating system, and particularly an optimizer module such as optimizer module 122, classifies the operating state of the target process and of the information handling system in block 214, and a decision is made as to whether or not the information handling system is configured to optimize power consumption in decision block 216. If so, the “YES” branch of decision block 216 is taken, the host operating system directs the storage device driver to set the storage device in the low I/O (LOW) operating mode in block 218, and the method returns to decision block 206, as described above. If the information handling system is not configured to optimize the power consumption, the “NO” branch of decision block 216 is taken and an optimization class for reads and writes to the storage device is determined in block 220.

A decision is made as to whether a ratio of data writes to data reads for the target process is greater than a first threshold in decision block 222. If not, the “NO” branch of decision block 222 is taken and the method proceeds to decision block 228, as described below. If the ratio of data writes to data reads is greater than the first threshold, the “YES” branch of decision block 222 is taken and a decision is made as to whether or not the storage device is in need of housekeeping operations in decision block 224. If so, the “YES” branch of decision block 224 is taken and the method proceeds to block 210, as described above. If the storage device is not in need of the housekeeping operations, the “NO” branch of decision block 224 is taken, the host operating system directs the storage device driver to set the storage device in the write-optimized (TB_W) operating mode in block 226, and the method returns to decision block 206, as described above.

Returning to decision block 222, when the ratio of data writes to data reads is not greater than the first threshold, and the “NO” branch of the decision block is taken, a decision is made as to whether or not the ratio of data writes to data reads is less than a second threshold, the second threshold being lower than the first threshold, in decision block 228. If not, the “NO” branch of decision block 228 is taken and the method proceeds to decision block 234, as described below. If the ratio of data writes to data reads is less than the second threshold, the “YES” branch of decision block 228 is taken and a decision is made as to whether or not the storage device is in need of housekeeping operations in decision block 230. If so, the “YES” branch of decision block 230 is taken and the method proceeds to block 210, as described above. If the storage device is not in need of the housekeeping operations, the “NO” branch of decision block 230 is taken, the host operating system directs the storage device driver to set the storage device in the read-optimized (TB_R) operating mode in block 232, and the method returns to decision block 206, as described above.

Returning to decision block 228, when the ratio of data writes to data reads is not less than the second threshold, that is, when the ratio of data writes to data reads is between the first threshold and the second threshold, and the “NO” branch of decision block 228 is taken, a decision is made as to whether or not the storage device is in need of housekeeping operations in decision block 234. If so, the “YES” branch of decision block 234 is taken and the method proceeds to block 210, as described above. If the storage device is not in need of the housekeeping operations, the “NO” branch of decision block 234 is taken, the host operating system directs the storage device driver to set the storage device in the standard (STD) operating mode in block 236, and the method returns to decision block 206, as described above.

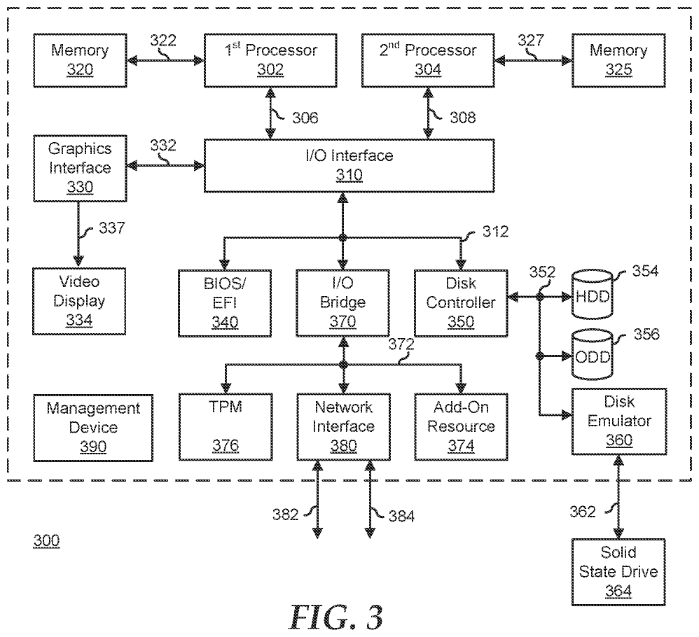

FIG. 3 illustrates a generalized embodiment of an information handling system 300. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 300 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 300 can include processing resources for executing machine-executable code, such as a central processing unit (CPU), a programmable logic array (PLA), an embedded device such as a System-on-a-Chip (SoC), or other control logic hardware. Information handling system 300 can also include one or more computer-readable medium for storing machine-executable code, such as software or data. Additional components of information handling system 300 can include one or more storage devices that can store machine-executable code, one or more communications ports for communicating with external devices, and various input and output (I/O) devices, such as a keyboard, a mouse, and a video display. Information handling system 300 can also include one or more buses operable to transmit information between the various hardware components.

Information handling system 300 can include devices or modules that embody one or more of the devices or modules described below, and operates to perform one or more of the methods described below. Information handling system 300 includes a processors 302 and 304, an input/output (I/O) interface 310, memories 320 and 325, a graphics interface 330, a basic input and output system/universal extensible firmware interface (BIOS/UEFI) module 340, a disk controller 350, a hard disk drive (HDD) 354, an optical disk drive (ODD) 356, a disk emulator 360 connected to an external solid state drive (SSD) 364, an I/O bridge 370, one or more add-on resources 374, a trusted platform module (TPM) 376, a network interface 380, a management device 390, and a power supply 395. Processors 302 and 304, I/O interface 310, memory 320, graphics interface 330, BIOS/UEFI module 340, disk controller 350, HDD 354, ODD 356, disk emulator 360, SSD 364, I/O bridge 370, add-on resources 374, TPM 376, and network interface 380 operate together to provide a host environment of information handling system 300 that operates to provide the data processing functionality of the information handling system. The host environment operates to execute machine-executable code, including platform BIOS/UEFI code, device firmware, operating system code, applications, programs, and the like, to perform the data processing tasks associated with information handling system 300.

In the host environment, processor 302 is connected to I/O interface 310 via processor interface 306, and processor 304 is connected to the I/O interface via processor interface 308. Memory 320 is connected to processor 302 via a memory interface 322. Memory 325 is connected to processor 304 via a memory interface 327. Graphics interface 330 is connected to I/O interface 310 via a graphics interface 332, and provides a video display output 336 to a video display 334. In a particular embodiment, information handling system 300 includes separate memories that are dedicated to each of processors 302 and 304 via separate memory interfaces. An example of memories 320 and 325 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 340, disk controller 350, and I/O bridge 370 are connected to I/O interface 310 via an I/O channel 312. An example of I/O channel 312 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 310 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 340 includes BIOS/UEFI code operable to detect resources within information handling system 300, to provide drivers for the resources, initialize the resources, and access the resources. BIOS/UEFI module 340 includes code that operates to detect resources within information handling system 300, to provide drivers for the resources, to initialize the resources, and to access the resources.

Disk controller 350 includes a disk interface 352 that connects the disk controller to HDD 354, to ODD 356, and to disk emulator 360. An example of disk interface 352 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 360 permits SSD 364 to be connected to information handling system 300 via an external interface 362. An example of external interface 362 includes a USB interface, an IEEE 2394 (Firewire) interface, a proprietary interface, or a combination thereof. Alternatively, solid-state drive 364 can be disposed within information handling system 300.

I/O bridge 370 includes a peripheral interface 372 that connects the I/O bridge to add-on resource 374, to TPM 376, and to network interface 380. Peripheral interface 372 can be the same type of interface as I/O channel 312, or can be a different type of interface. As such, I/O bridge 370 extends the capacity of I/O channel 312 when peripheral interface 372 and the I/O channel are of the same type, and the I/O bridge translates information from a format suitable to the I/O channel to a format suitable to the peripheral channel 372 when they are of a different type. Add-on resource 374 can include a data storage system, an additional graphics interface, a network interface card (NIC), a sound/video processing card, another add-on resource, or a combination thereof. Add-on resource 374 can be on a main circuit board, on separate circuit board or add-in card disposed within information handling system 300, a device that is external to the information handling system, or a combination thereof.

Network interface 380 represents a NIC disposed within information handling system 300, on a main circuit board of the information handling system, integrated onto another component such as I/O interface 310, in another suitable location, or a combination thereof. Network interface device 380 includes network channels 382 and 384 that provide interfaces to devices that are external to information handling system 300. In a particular embodiment, network channels 382 and 384 are of a different type than peripheral channel 372 and network interface 380 translates information from a format suitable to the peripheral channel to a format suitable to external devices. An example of network channels 382 and 384 includes InfiniBand channels, Fibre Channel channels, Gigabit Ethernet channels, proprietary channel architectures, or a combination thereof. Network channels 382 and 384 can be connected to external network resources (not illustrated). The network resource can include another information handling system, a data storage system, another network, a grid management system, another suitable resource, or a combination thereof.

Management device 390 represents one or more processing devices, such as a dedicated baseboard management controller (BMC) System-on-a-Chip (SoC) device, one or more associated memory devices, one or more network interface devices, a complex programmable logic device (CPLD), and the like, that operate together to provide the management environment for information handling system 300. In particular, management device 390 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 300, such as system cooling fans and power supplies. Management device 390 can include a network connection to an external management system, and the management device can communicate with the management system to report status information for information handling system 300, to receive BIOS/UEFI or system firmware updates, or to perform other task for managing and controlling the operation of information handling system 300. Management device 390 can operate off of a separate power plane from the components of the host environment so that the management device receives power to manage information handling system 300 when the information handling system is otherwise shut down. An example of management device 390 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 390 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An information handling system, comprising:
a storage device configured to operate in one of a plurality of operating modes; and
a host operating system configured to determine an operating state of the information handling system, to select an operating mode based upon the operating state of the information handling system, and to direct the storage device to operate in the selected operating state;
wherein the storage device is further configured to implement the selected operating state in response to the direction.

2. The information handling system of claim 1, wherein the operating state includes a low-power state of the information handling system.

3. The information handling system of claim 2, wherein the operating modes include a low-input/output operating mode, and wherein, in response to determining that the information handling system is operating in the low-power state, the host operating system is configured to direct the storage device to operate in the low-input/output operating mode.

4. The information handling system of claim 1, wherein, the operating modes further include a data write optimized mode and a data read optimized mode.

5. The information handling system of claim 4, wherein, in determining the operating state of the information handling system, the host operating system is further configured to determine a ratio of data writes to data reads from a workload instantiated on the information handling system to the storage device.

6. The information handling system of claim 5, wherein, when the ratio is greater than a first threshold, the host operating system is further configured to direct the storage device to operate in the data write optimized mode.

7. The information handling system of claim 6, wherein, when the ratio is less than a second threshold, the host operating system is further configured to direct the storage device to operate in the data read optimized mode, wherein the second threshold is lower than the first threshold.

8. The information handling system of claim 7, wherein, when the ratio is between the first and second threshold, the host operating system is further configured to direct the storage device to operate in a standard operating mode.

9. The information handling system of claim 1, wherein the operating modes include a housekeeping operating mode.

10. The information handling system of claim 1, further comprising:
a storage device driver configured to receive the direction from the host operating system and to provide the direction to the storage device.

11. A method, comprising:
providing, on an information handling system, a storage device configured to operate in one of a plurality of operating modes;
determining, by a host operating system instantiated on the information handling system, an operating state of the information handling system;
selecting an operating mode based upon the operating state of the information handling system;
directing the storage device to operate in the selected operating state; and
implementing, by the storage device, the selected operating state in response to the direction.

12. The method of claim 11, wherein the operating state includes a low-power state of the information handling system.

13. The method of claim 12, wherein:
the operating modes include a low-input/output operating mode, and
wherein, in response to determining that the information handling system is operating in the low-power state, the method further comprise directing the storage device to operate in the low-input/output operating mode.

14. The method of claim 11, wherein, the operating modes further include a data write optimized mode and a data read optimized mode.

15. The method of claim 14, wherein, in determining the operating state of the information handling system, the method further comprises:
determining, by the host operating system, a ratio of data writes to data reads from a workload instantiated on the information handling system to the storage device.

16. The method of claim 15, wherein, when the ratio is greater than a first threshold, the method further comprises:
directing the storage device to operate in the data write optimized mode.

17. The method of claim 16, wherein, when the ratio is less than a second threshold, the second threshold being lower than the first threshold, the method further comprises:
directing the storage device to operate in the data read optimized mode,.

18. The method of claim 17, wherein, when the ratio is between the first and second threshold, the method further comprises:
directing the storage device to operate in a standard operating mode.

19. The method of claim 1, wherein the operating modes include a housekeeping operating mode.

20. An information handling system, comprising:
a solid state drive (SSD) configured to operate in one of a plurality of operating modes; and
a host operating system configured to determine an operating state of the information handling system, to select an operating mode based upon the operating state of the information handling system, and to direct the SSD to operate in the selected operating state;
wherein the SSD is further configured to implement the selected operating state in response to the direction.
